(19) United States
(12) Patent Application Publication
(10) Pub. No.: US 2024/0067435 A1
(43) Pub. Date: Feb. 29, 2024

(54) STAND-UP BAG FOR MICROWAVING FRESH PRODUCE WITH BREACHABLE SAUCE POUCH

(71) Applicant: EarthFresh Foods Incorporated, Burlington (CA)

(72) Inventor: Caihua SHI, Burlington (CA)

(21) Appl. No.: 18/457,554

(22) Filed: Aug. 29, 2023

Related U.S. Application Data
(60) Provisional application No. 63/373,762, filed on Aug. 29, 2022.

(51) Int. Cl. B65D 81/32; A47J 36/02; A47J 36/04; B65D 33/01; B65D 75/00; B65D 75/30; B65D 75/38; B65D 75/58; B65D 81/34

(52) U.S. Cl. CPC B65D 81/3272; A47J 36/027; A47J 36/04; B65D 33/01; B65D 75/008; B65D 75/30; B65D 75/38; B65D 75/58; B65D 81/3461; B65D 2205/02; B65D 2207/00; B65D 2581/3427; B65D 2581/3432

(57) ABSTRACT

Disclosed is a stand-up microwavable bag for cooking fresh produce. The bag includes a self-saucing mechanism that automatically deposits flavour sauces onto the produce during microwaving. A steam pressure release valve is provided to balance internal steam pressure during microwaving to prevent bag explosion. The bag is also designed to extend the shelf life of produce (whole or pre-cut) to reduce food waste.

### CROSS-REFERENCE TO RELATED APPLICATIONS

This application claims priority from U.S. Provisional Patent Application No. 63/373,762, filed Aug. 29, 2022, the disclosure of which is hereby incorporated herein in its entirety by reference.

### FIELD OF THE DISCLOSURE

The present disclosure relates generally to the field of microwavable stand-up bags, specifically to microwavable stand-up bags to cook fresh produce, more specifically to microwavable stand-up bags to cook fresh produce that also contain a self-popping sauce pouch.

### BACKGROUND

Any discussion of the related art throughout the specification should in no way be considered as an admission that such related art is widely known or forms part of common general knowledge in the field.

Stand-up microwavable bags are known in the field, including: U.S. Pat. Nos. 11,242,188; 8,087,827; 7,781,036; 6,488,973 and EP Patent No: 2011742.

Some of the known stand-up microwavable bags can deposit flavored sauces on the produce during cooking, others have means of allowing the steam to escape during cooking, others have perforated surfaces to prolong the shelf life of the produce.

All documents cited herein are incorporated by reference.

None of the above cited documents, alone or in combination satisfy the need for a stand-up microwavable bag that is able to deposit flavored sauces on the produce during cooking, allow steam to escape during cooking, and to prolong the shelf life of the fresh produce contained within.

### BRIEF SUMMARY

It is an object of the disclosure to provide a microwavable stand-up bag to cook fresh produce with a self-popping sauce pouch.

In accordance with an aspect of the disclosure, there is provided a stand-up bag for microwaving produce said bag comprising: opposing parallel walls heat sealed together to form the stand-up bag, having a top, and a base, and forming an inner compartment; a skip seal formed by heat sealing the opposing parallel walls, dividing the stand-up bag into an upper compartment and a lower compartment; a breachable sauce pouch contained in the upper compartment; a series of micro perforations formed in one or more of the opposing parallel walls extending from the inner compartment to an exterior surface; and a steam valve situated in one of the opposing parallel walls, extending from the inner compartment to an exterior surface.

In one embodiment, the base comprises a gusset.

In one embodiment, the stand-up bag is fabricated from a film comprising polypropylene and polyamide.

In one embodiment, the breachable sauce pouch is fabricated from a film comprising polypropylene and polyester.

In one embodiment, the skip seal is in the form of a horizontal dashed seal that extends across the bag, approximately parallel with the top.

In one embodiment, the skip seal is in the shape of a chevron extending from opposing edges of the walls down towards a central region of the bag.

In one embodiment, the breachable sauce pouch has a breachable section formed by laser scoring.

In one embodiment, the laser scoring is in the form of a continuous line, a dotted line or a dashed line.

In one embodiment, the laser scoring is between 45 μm-600 μm.

In one embodiment, the opposing parallel walls are laser-perforated with micro-holes.

In one embodiment, laser-perforated micro-holes have substantially a 75 μm diameter.

The advantages and features of the present disclosure will become better understood with reference to the following more detailed description and claims taken in conjunction with the accompanying drawings in which like elements are identified with like symbols.

### BRIEF DESCRIPTION OF THE DRAWINGS

To easily identify the discussion of any particular element or act, the most significant digit or digits in a reference number refer to the figure number in which that element is first introduced.

In the figures, embodiments are illustrated by way of example. It is to be expressly understood that the description and figures are only for the purpose of illustration and as an aid to understanding.

Embodiments will now be described, by way of example only, with reference to the attached figures.

FIG. 1A illustrates a side view of an embodiment of a stand-up bag.

FIG. 1B illustrates an aspect of the stand-up bag in accordance with one embodiment.

FIG. 2 illustrates a side view of a sauce pouch in accordance with one embodiment.

FIG. 3A illustrates an aspect of a laser score line in accordance with one embodiment.

FIG. 3B illustrates an aspect of the laser score line in accordance with one embodiment.

FIGS. 4A and B illustrate aspects of a laser score line in accordance with one embodiment.

FIG. 5A illustrates a dotted laser score line in accordance with one embodiment.

FIG. 5B illustrates the dotted laser score line in accordance with one embodiment.

FIG. 6A illustrates a dashed laser score line in accordance with one embodiment.

FIG. 6B illustrates a dashed laser score line in accordance with one embodiment.

FIG. 7A illustrates experimental results in accordance with one embodiment.

FIG. 7B illustrates experimental results in accordance with one embodiment.

FIG. 7C illustrates experimental results in accordance with one embodiment.

FIG. 8A illustrates a dotted laser score line formed in a sauce pouch in accordance with one embodiment.

FIG. 8B illustrates a dotted laser score line formed in a sauce pouch in accordance with one embodiment.

FIG. 9A illustrates experimental results in accordance with one embodiment.

FIG. 9B illustrates experimental results in accordance with one embodiment.

FIG. 10A illustrates experimental results in accordance with one embodiment.

FIG. 10B illustrates experimental results in accordance with one embodiment.

FIG. 10C illustrates experimental results in accordance with one embodiment.

FIG. 10D illustrates experimental results in accordance with one embodiment.

FIG. 11 illustrates a steam valve in accordance with one embodiment.

FIG. 12A illustrates a steam valve in accordance with one embodiment.

FIG. 12B illustrates a steam valve in accordance with one embodiment.

FIG. 13 illustrates a horizontal skip seal in accordance with one embodiment.

FIG. 14 illustrates a v-shaped skip seal in accordance with one embodiment.

FIG. 15 illustrates experimental results in accordance with one embodiment.

FIG. 16 illustrates experimental results in accordance with one embodiment.

FIG. 17 illustrates a v-shaped skip seal in accordance with one embodiment.

FIG. 18 illustrates a stand-up microwavable bag in accordance with one embodiment.

FIG. 19 illustrates a stand-up microwavable bag in accordance with one embodiment.

Elements in the several drawings are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Devices and methods for carrying out the disclosure are presented in terms of embodiments depicted within the FIGS. However, the disclosure is not limited to the described embodiments, and a person skilled in the art will appreciate that many other embodiments of the disclosure are possible without deviating from the basic concept of the disclosure, and that any such work around will also fall under scope of this disclosure. It is envisioned that other styles and configurations of the present disclosure can be easily incorporated into the teachings of the present disclosure, and the configurations shall be shown and described for purposes of clarity and disclosure and not by way of limitation of scope.

It is an object of embodiments of the disclosure to provide a stand-up bag for heating food that automatically deposits flavor sauces onto the food during microwave cooking.

Additional objects of embodiments of the disclosure relate to a stand-up bag that typically comprises an upper compartment and a lower compartment.

Further objects of embodiments of the disclosure include a skip seal between the upper and lower compartments. The skip seal provides the following functionality: it holds the sauce pouch in the upper compartment; it allows the sauce to flow from the upper compartment when the pouch is breached and flow onto the produce in the lower compartment during microwave heating; and the angle and orientation of the seal increases the rigidity of the bag, assisting it to stand up.

Further objects of embodiments of the disclosure include a self-popping sauce pouch situated in the upper compartment of the stand-up bag. The self-popping sauce pouch is custom made to such that it bursts open when steam builds up during the cooking process. Various techniques can be used to achieve the breaching of the sauce pouch, including but not limited to, creating a laser pre-scored weakened section of the pouch, such that pressure is built up inside the pouch during heating causing the laser scored area to burst open releasing the sauce to the lower compartment.

Yet further objects of embodiments of the disclosure include micro-perforated holes formed on the bag to create an internal modified atmospheric environment with specific headspace oxygen and carbon dioxide concentrations for extended shelf life of the fresh produce contained within.

Still further objects of embodiments of the disclosure include a steam valve situated on the stand-up bag such that during microwave cooking, pressure build within the bag causes the steam valve to open and release it in a controlled manner.

Hence the problem solved by the various embodiments of the disclosure are to provide a microwavable consumer packaged product that provides a self-saucing mechanism. Consumers do not need to manually open the bag to deposit the sauce onto the food during cooking. Also, the stand-up bag substantially reduces cooking times and meal preparation time as well as preserving the nutrients.

Challenges of the present disclosure included (1) to develop a self-saucing mechanism that automatically deposits flavour sauces onto vegetables during microwaving; (2) to balance internal steam pressure during microwaving to prevent bag explosion; (3) to separate the sauce pouch from produce without interfering the deposit of flavour sauce; (4) to extend the shelf life of produce (whole or pre-cut) to reduce food waste. Solutions implemented to overcome these challenges are explained below.

To ensure the functionality of the self-popping sauce pouch, the flavour sauce was designed as a blend of water, oil, emulsifier, seasoning, and herb particulates. The moisture content was added (1) to generate steam to expand the sauce pouch, causing pouch bursting at the laser score line; (2) to reduce viscosity of the flavour sauce to prevent overheating; (3) to lower pH value of the flavour sauce as the carrier of natural acid to control growth of foodborne pathogens. Oil was added to provide texture and deliver flavour. The ratio between water and oil was designed to promote pouch bursting at the early stage of microwave-cooking to prevent overcooked flavour sauce. Moreover, emulsifier was used to blend the flavour sauce into a homogeneous form.

The features of the disclosure which are believed to be novel are particularly pointed out in the specification. The present disclosure now will be described more fully hereinafter with reference to the accompanying drawings, which are intended to be read in conjunction with both this summary, the detailed description and any preferred and/or particular embodiments specifically discussed or otherwise disclosed. This disclosure may, however, be embodied in many different forms and should not be construed as limited to the embodiments set forth herein; rather, these embodiments are provided by way of illustration only and so that this disclosure will be thorough, complete and will fully convey the full scope of the disclosure to those skilled in the art.

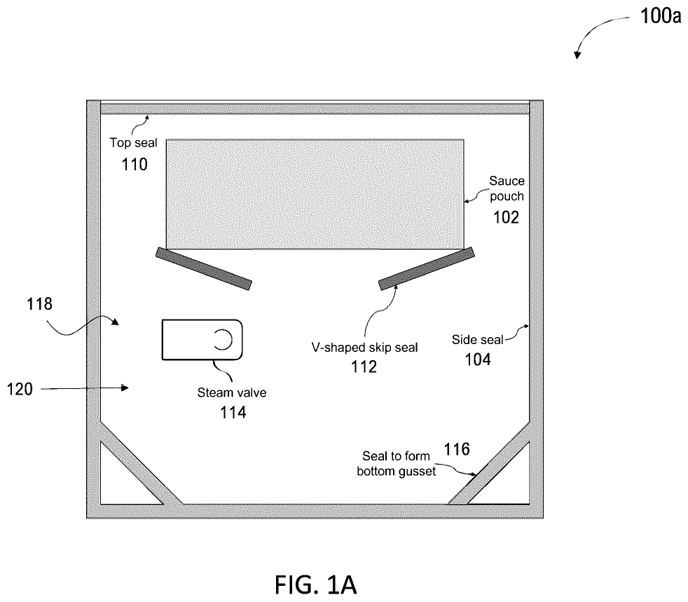

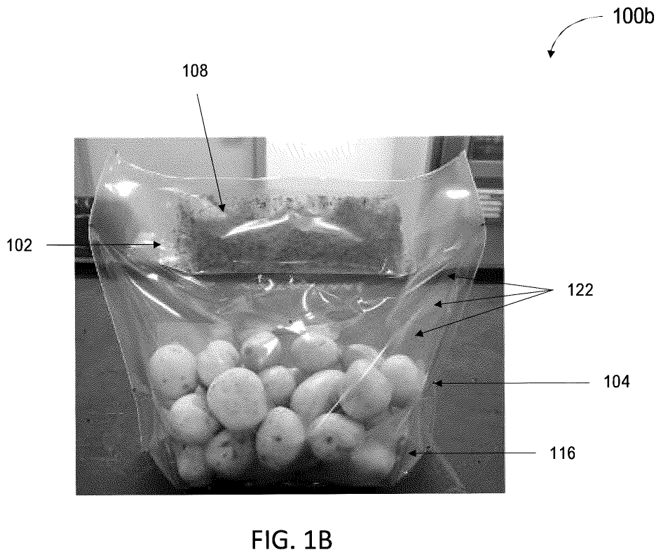

FIG. 1A illustrates a side view of an embodiment of the stand-up bag.

A schematic of a stand-up microwavable bag 100a is shown. The stand-up microwavable bag 100a has similarly sized front surface 118 and a rear surface 120 which are sealed around their edges via side seals 104, bottom gusset seals 116 and a top seal 110. The bottom gusset seal 116 provides room for fresh produce and supports the stand-up bag design.

A steam valve 114 is formed on one or the outer surfaces of the bag, either the front surface 118 or the rear surface 120. The steam valve 114 balances the extreme pressure built up within the stand-up microwavable bag 100a during microwave cooking.

In the illustrated embodiment, a v-shaped skip seal 112 is formed by heat sealing sections of the front surface 118 to the rear surface 120. The resulting v-shaped skip seal 112 can be seen extending partially across an upper portion of the stand-up microwavable bag 100a supporting a sauce pouch 102. The sauce pouch 102 having a predetermined breach threshold responsive to the pressure.

FIG. 1B shows a photo of produce contained in an embodiment of the microwavable stand-up bag 100b.

The material that is used to form the front surface 118 and rear surface 120 of the microwavable stand-up bag 100b contains micro-holes 122 that are created via laser-perforation. The micro-holes 122 create modified atmosphere within the microwavable stand-up bag 100b based on the respiration rate of the produce contained within the microwavable stand-up bag 100b.

The photo shows the microwavable stand-up bag 100b containing fresh potatoes and having a sauce pouch 102 suspended above the produce via the v-shaped skip seal 112.

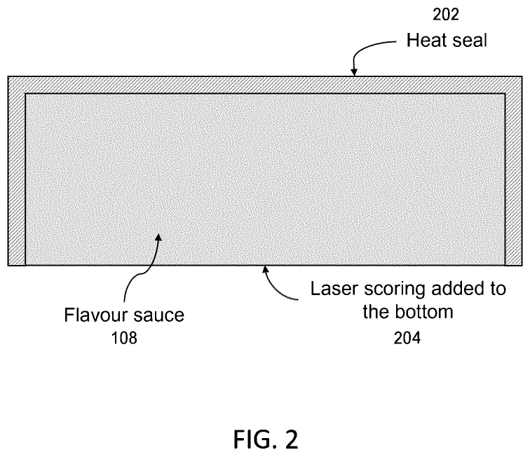

FIG. 2 illustrates a side view of a sauce pouch in accordance with an embodiment of the disclosure.

The schematic diagram shows a rectangular sauce pouch 102 having heat seals 202 around three of the sides and a laser scored section 204 along a bottom edge of the sauce pouch 102. In the microwave oven, moisture content from the flavor sauce will generate substantial amount of steam to expand the pouch and burst at the laser scoring which is the weakest spot.

The laser-scored sauce pouch 102 is separated from the produce by the skip seal and thereby automatically deposits the flavor sauce 108 onto the produce during the cooking process in the microwave oven.

The sauce pouch 102 design uses conventional food grade polyester/polypropylene film with laser score line at the bottom as the weak spot. The laser score line was designed to promote pouch bursting in a timely behavior during microwaving while maintaining the film integrity to prevent sauce leakage prior to cooking. To address this functional challenge, various laser scoring patterns have been tested.

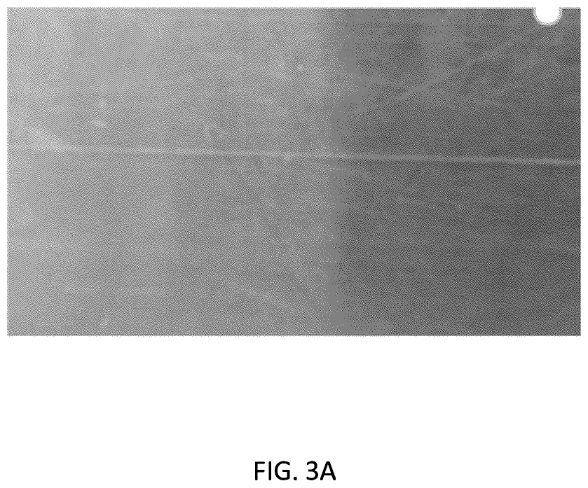

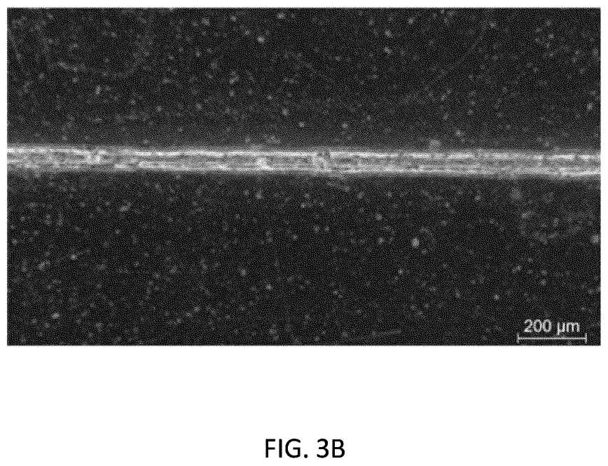

FIG. 3A illustrates a photo of a continuous laser score line.

This laser score line was produced having a width of 85 nm following a continuous line pattern.

FIG. 3B illustrates a digital light microscope image of the continuous laser score line shown in FIG. 3A.

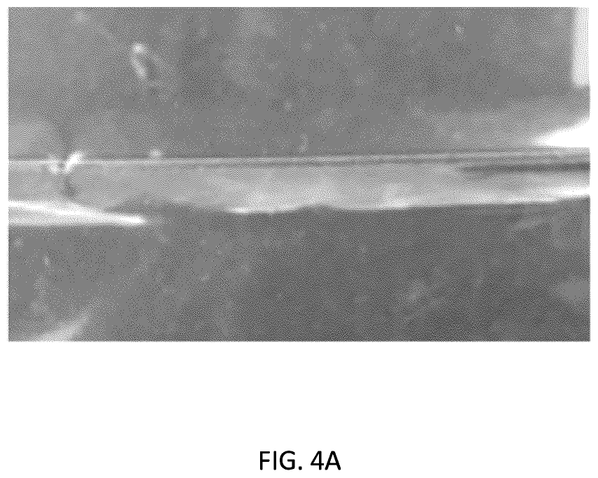

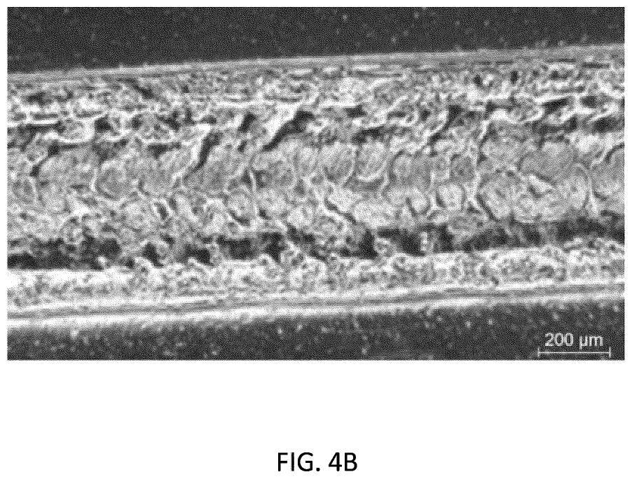

FIG. 4A illustrates a photo of an alternative continuous laser score line.

This laser score line was produced having a width of 600 nm following a continuous line pattern.

FIG. 4B illustrates a digital light microscope image of the continuous laser score line shown in FIG. 4A.

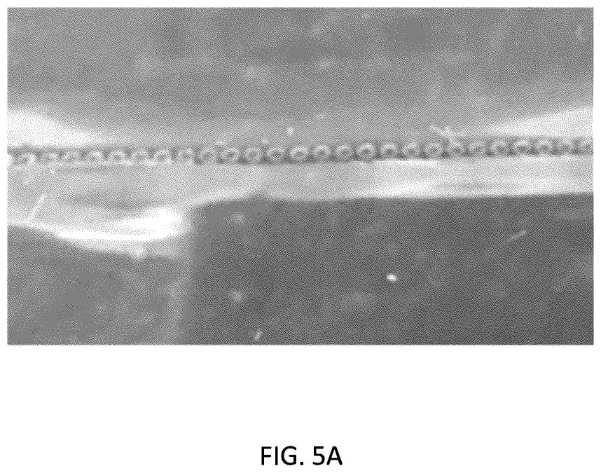

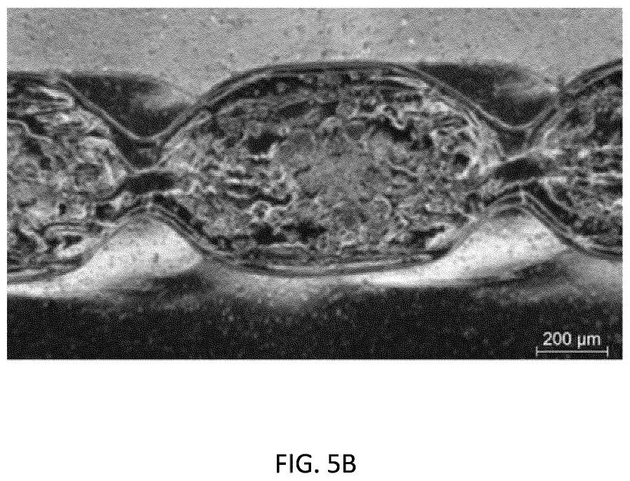

FIG. 5A illustrates a photo of a dotted laser score line.

This laser score dotted line was produced having a width of 600 nm following a continuous line pattern.

FIG. 5B illustrates a digital light microscope image of the dotted laser score line shown in FIG. 5A.

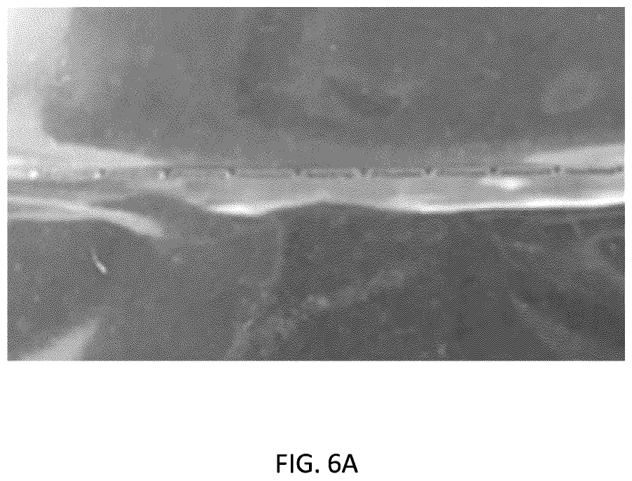

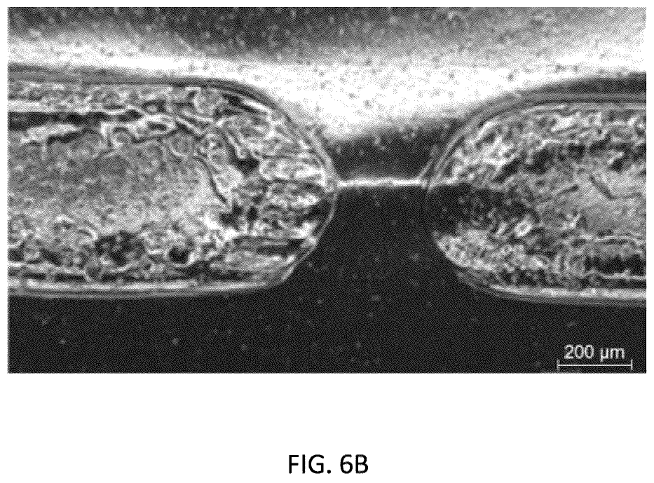

FIG. 6A illustrates a photo of a dashed laser score line.

This laser score dashed line was produced having a width of 600 nm following a continuous line pattern.

FIG. 6B illustrates a digital light microscope image of the dashed laser score line shown in FIG. 6A.

Microscopic images showed the laser beam only melted the material but not vaporized the film to form a groove on samples shown in FIG. 4A, FIG. 4B, FIG. 5A, FIG. 5B, FIG. 6A and FIG. 6B. The molten material was more resistant to pouch bursting. Cooking tests also showed small holes were formed on both continuous and dashed line patterns

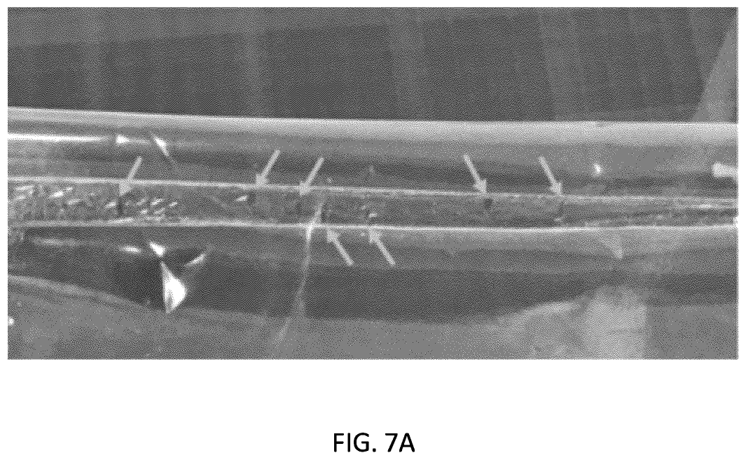

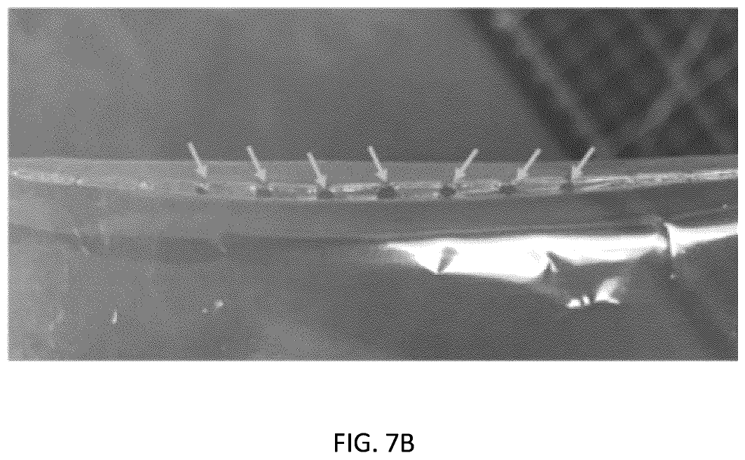

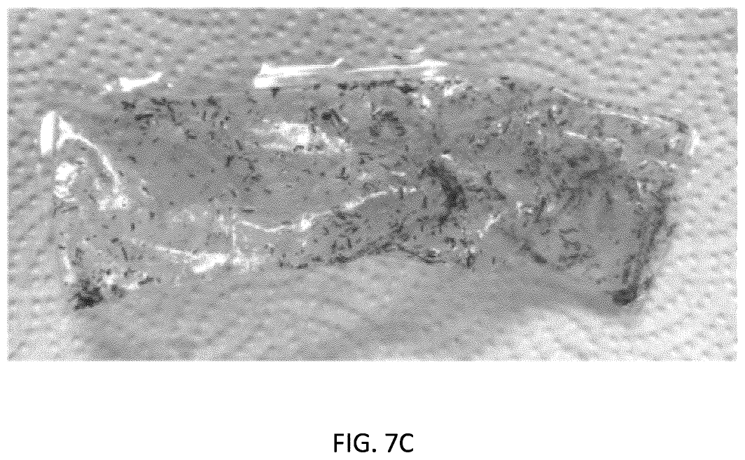

FIG. 7A illustrates results obtained from cooking tests using the laser scored continuous line (600 μm) sauce pouch 102 shown and described in FIG. 4A and FIG. 4B.

As can be seen, there was limited pouch bursting and resulting in burnt herb particulates.

FIG. 7B illustrates results obtained from cooking tests using the laser scored dashed line (600 μm) sauce pouch 102 shown and described in FIG. 6A and FIG. 6B.

Small holes were formed on the dashed laser score line after microwave cooking.

FIG. 7C illustrates results obtained from cooking tests using the laser scored dotted line (600 μm) sauce pouch 102 shown and described in FIG. 5A and FIG. 5B.

The dotted laser score line was partially opened in a microwave after cooking.

The ideal design is pouch bursting along the entire laser incision.

Based on evaluation results, further experiments were performed reducing the width of laser scoring with more energy concentrated on the film to vaporize the material. Sauce pouches 102 with 45 μm and 85 μm dotted line laser scoring were evaluated.

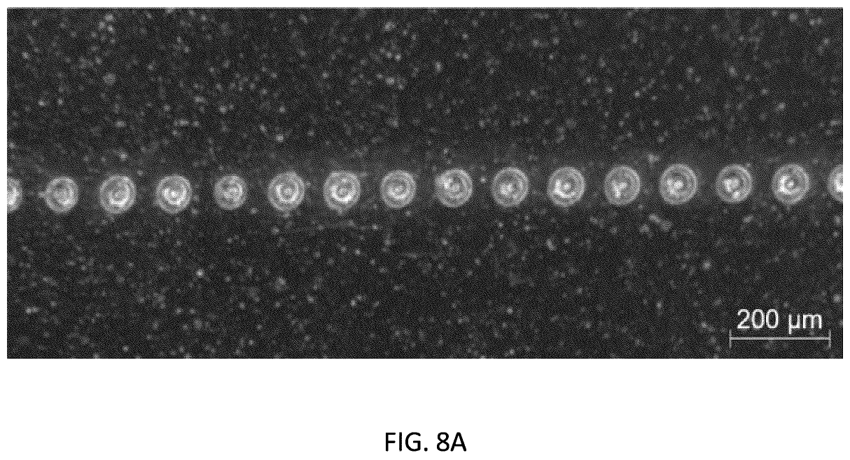

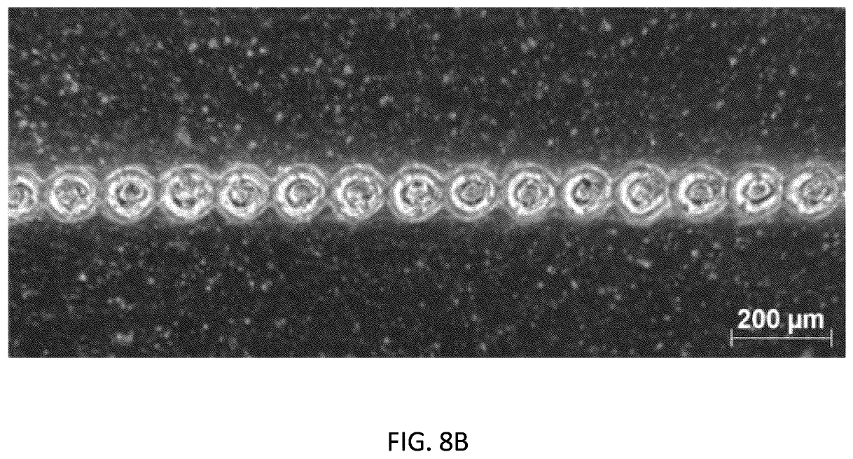

FIG. 8A illustrates a digital light microscope image of a dotted laser score line formed in a sauce pouch 102. The dotted laser score line had a width of 45 μm.

FIG. 8B illustrates a digital light microscope image of a dotted laser score line formed in a sauce pouch 102. The dotted laser score line had a width of 85 μm.

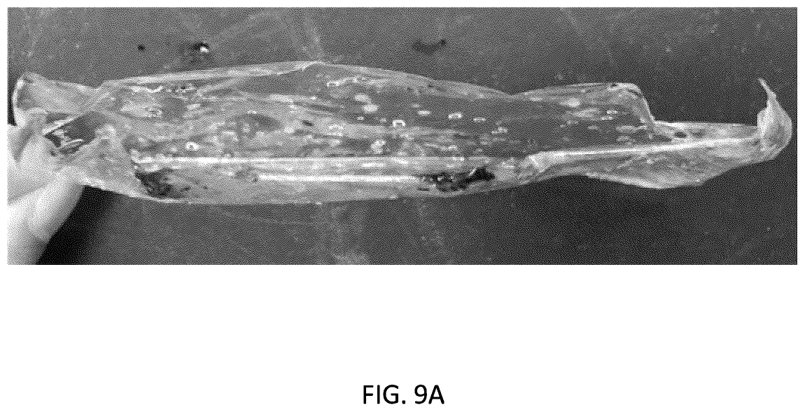

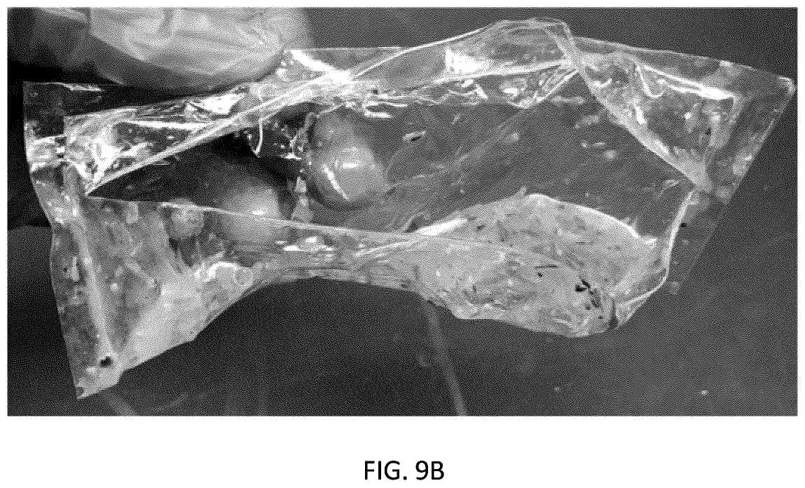

FIG. 9A illustrates results obtained after microwave cooking of the sauce pouch 102 shown in FIG. 8B

It can be seen that the entire laser score line was opened with the 85 μm dotted line pattern.

FIG. 9B illustrates results obtained after microwave cooking of the sauce pouch 102 shown in FIG. 8A

It can be seen that the sauce pouch 102 burst at the front panel when the film was scored with 45 μm dotted line, suggesting insufficient laser incision.

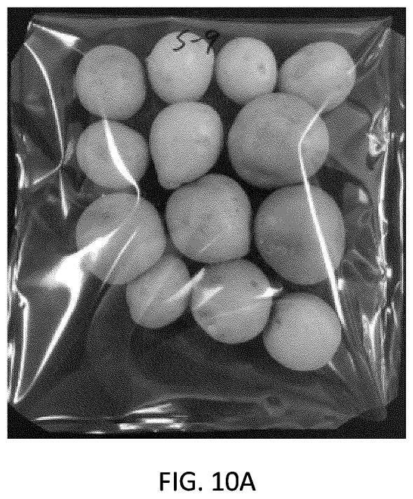

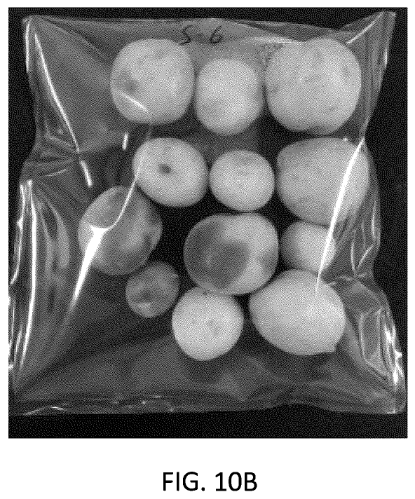

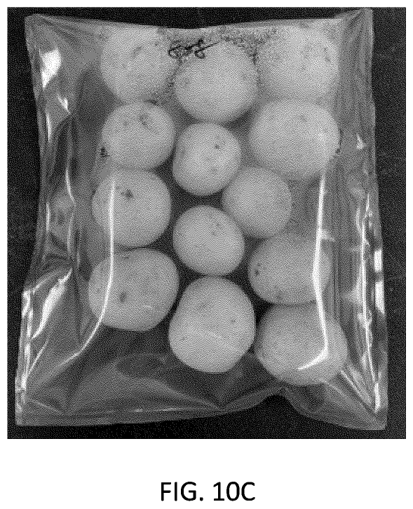

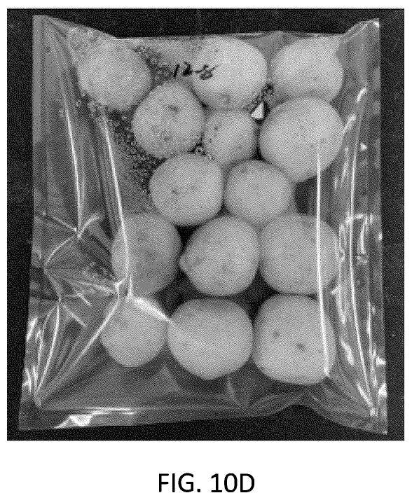

FIG. 10A illustrates an image of potatoes packed in a clear bag after 2-week storage at the display refrigerator (approximately 8° C.) with continuous light exposure.

This sample shows a control wherein 4 corners were cut off to allow ventilation. The potatoes started showing greening from Week 2.

FIG. 10B illustrates an image of potatoes packed in a clear bag after 2-week storage at the display refrigerator (approximately 8° C.) with continuous light exposure.

This sample shows a bag that was laser-perforated with 4 micro-holes with 75 nm in diameter. The potatoes started showing darkening due to excessively high carbon dioxide concentration after 2-week storage.

FIG. 10C illustrates an image of potatoes packed in a clear bag after 2-week storage at the display refrigerator (approximately 8° C.) with continuous light exposure.

This sample shows a bag that was laser-perforated with 8 micro-holes with 75 nm in diameter. No darkening or greening was noticed, suggesting optimum modified atmosphere for storage of potatoes.

FIG. 10D illustrates an image of potatoes packed in a clear bag after 2-week storage at the display refrigerator (approximately 8° C.) with continuous light exposure.

This sample shows a bag that was laser-perforated with 12 micro-holes with 75 nm in diameter. Potatoes started showing greening after 2 weeks of storage.

Table 1—Mean headspace oxygen and carbon dioxide concentrations of Control (4 corners of the bag were cut off to allow ventilation) and laser-perforated bags with various numbers of micro-holes to create modified atmosphere after 2-week storage at the display refrigerator (approximately 8° C.) with continuous light exposure. Concentrations were mean±standard deviation (n=10).

TABLE 1

| Samples | O₂ concentration (%) | CO₂ concentration (%) |
|---|---|---|
| Control | 20.9 ± 0.0 | 0.0 ± 0.0 |
| 4 micro-holes | 4.7 ± 0.4 | 18.7 ± 0.4 |
| 8 micro-holes | 13.2 ± 0.4 | 9.0 ± 0.3 |
| 12 micro-holes | 13.7 ± 0.7 | 8.6 ± 0.7 |

The Micro-perforation data obtained, and described above in FIG. 10A-FIG. 10D and Table 1 demonstrated that the modified atmosphere with lower oxygen content and elevated carbon dioxide level created by laser-perforation on the packaging was implemented to extend the shelf life of bagged produce.

The above data was obtained using 450 g of baby yellow potatoes packed in each bag. The target oxygen content was programmed at 8% and the storage temperature was 8° C. The determined laser-perforation pattern required 4 micro-holes on each bag with 75 nm in diameter. Various numbers of micro-holes (4, 8, and 12) were studied to validate the target headspace concentration of oxygen. A Control group was prepared by cutting corners of the packaging, allowing for air flow. All sample bags were stored at a display refrigerator for 3 weeks with continuous light exposure.

The modified atmosphere was monitored using a headspace gas analyzer throughout the trial. Results showed sprouting and microbial decay were well controlled at the refrigerator environment for all potatoes. However, Control samples started showing green potatoes from Week 2 FIG. 10A. This greening process is the formation of chlorophyll on the skin when potato tubers are exposed to light. Greening of potatoes is generally considered as an indication of a concurrent reaction where glycoalkaloids are formed and accumulate on the peel. Glycoalkaloids will cause bitter flavor and burning sensation at medium level, whereas can be toxic at high content. Home-cooking methods, such as boiling, baking, and frying, cannot break down glycoalkaloids and therefore, it can cause significant waste of potatoes when tubers start showing greening.

With modified atmosphere packaging, greening of potatoes was not visible when the bag was perforated with 4 micro-holes, see FIG. 10B. However, potato tubers showed darkening in the second week of storage, due to excessively high carbon dioxide level (18.7% in Table 1).

With more micro-holes, both oxygen and carbon dioxide transmission rates of the entire packaging were increased, resulting in higher oxygen content and lower carbon dioxide level. FIG. 10C showed darkening of potatoes was not visible with more perforation on the packaging. Additionally, greening was not detected on tubers by visual inspection when the perforation was increased to 8 micro-holes on the bag, suggesting the equilibrium concentration of oxygen was optimum to delay greening process.

Lastly, potato tubers started displaying green skin from Week 2 when the bag was perforated with 12 micro-holes, see FIG. 10D, although the average headspace oxygen content (13.7%) was similar to the bag with 8-hole perforation (13.2%) in Table 1.

The respiration rate of potato tubers was likely higher as more oxygen was available with 12 micro-holes. Based on the results of shelf-life testing and headspace gas composition, modified atmosphere packaging with optimum laser perforation showed promising results to extend the shelf life of potatoes.

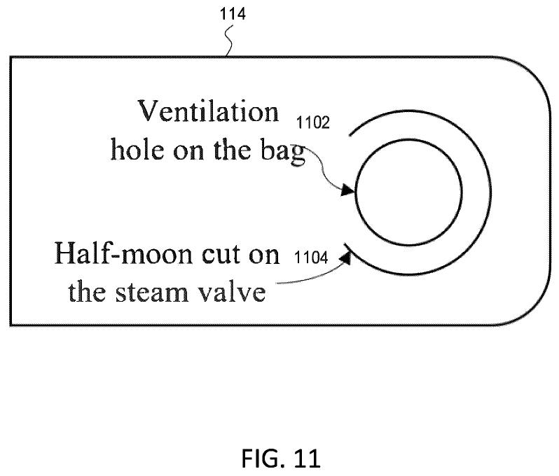

FIG. 11 illustrates a steam valve 114 in accordance with one embodiment of the disclosure.

During microwaving, moisture content in the fresh produce is heated up to generate substantial amount of steam. Although the steam can escape through laser perforations, preliminary tests showed these micro-holes were too small to release the pressure, resulting in bag explosion.

To address this problem, a steam valve was incorporated into the packaging design. Before microwave-cooking, the steam valve hermetically seals the bag to maintain the modified atmosphere. When the internal pressure reaches the threshold, the steam valve automatically opens to balance the extreme steam pressure.

The primary bag is firstly punctured to form a 6-mm ventilation hole 1102 which was determined by preliminary tests, followed by attachment of the steam valve using food grade adhesive. In the microwave, the half-moon membrane cut 1104 on the steam valve is pushed up by steam to release pressure.

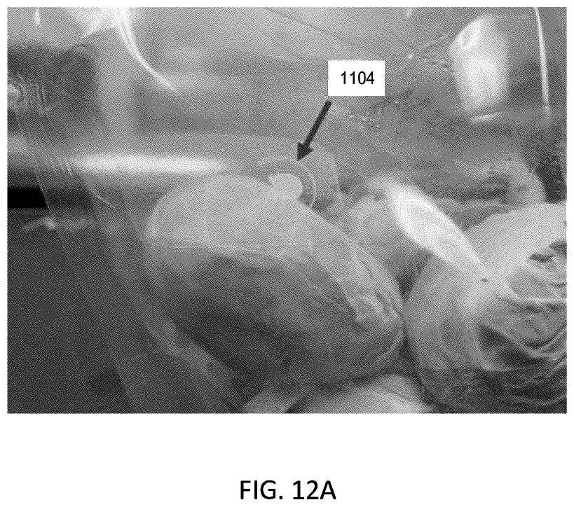

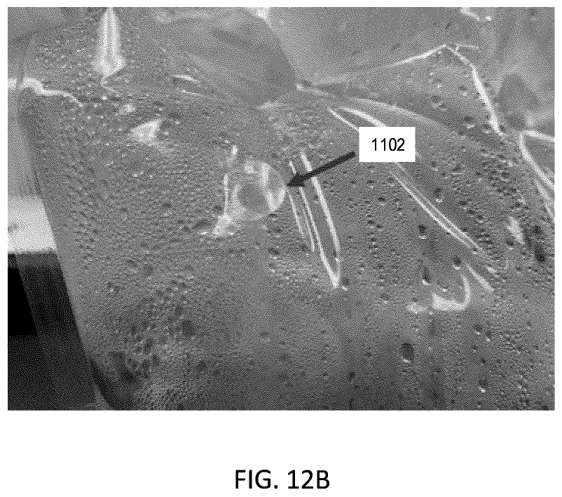

FIG. 12A illustrates a steam valve hermetically sealed the primary bag to maintain the modified atmosphere for extended shelf life of the produce.

FIG. 12B illustrates the steam valve opened as the internal steam pressure built up in a microwave oven.

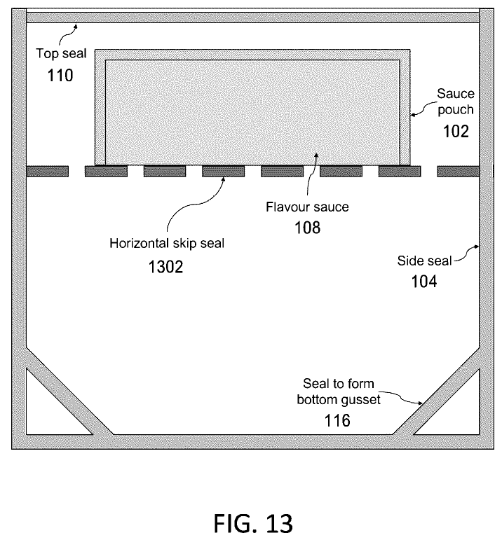

FIG. 13 illustrates a horizontal skip seal 1302.

At the initial development stage, the sauce pouch was directly placed on the produce. However, the problem of such configuration was the sauce pouch might slide in between vegetables during handling and shipping. Once the sauce pouch is covered, the produce can shield the microwave energy and prevent pouch bursting. To address this problem, a method to separate the sauce pouch from vegetables was needed. Additionally, this method must not block the deposit of flavor sauce onto the produce during microwaving. Based on these functional requirements, the skip seal was developed.

One embodiment of a horizontal skip seal 1302 consists of a series of heat sealed sections that bond the front surface 118 to the rear surface 120, and extend approximately horizontally across the stand-up microwavable bag 100a.

The horizontal skip seal 1302 separates the sauce pouch 102 from vegetables and channels between multiple sealing spots allowed the flow of flavour sauce.

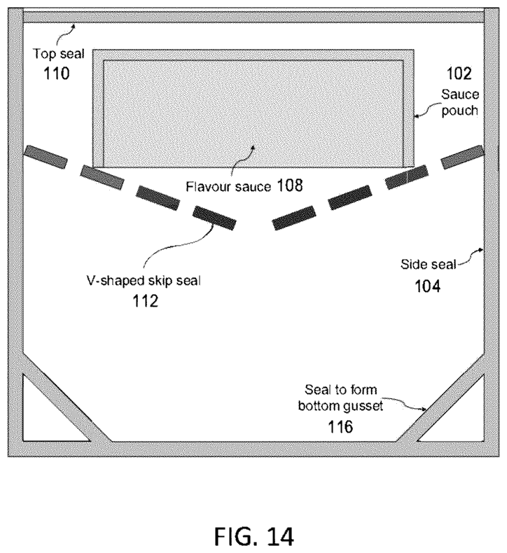

FIG. 14 illustrates a v-shaped skip seal 112.

An alternative embodiment comprises a v-shaped skip seal 112 that is formed in a chevron shape. It was found that this v-shaped skip seal 112 provides higher stiffness to support the stand-up bag design.

Proof of concept trials were conducted to finalize size, position, and angle of the V-shaped skip seal.

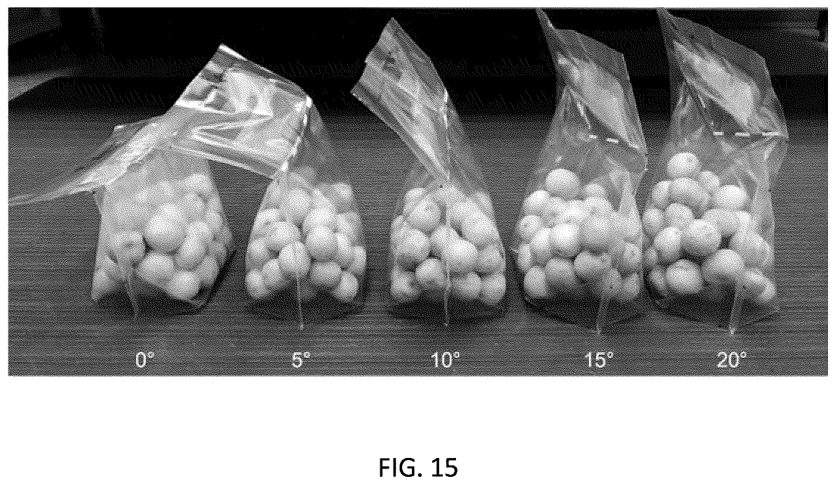

FIG. 15 illustrates results from the proof of concept trials.

This figure shows the top compartment of the primary bag loaded with the sauce pouch was better supported with increased angle of the skip seal.

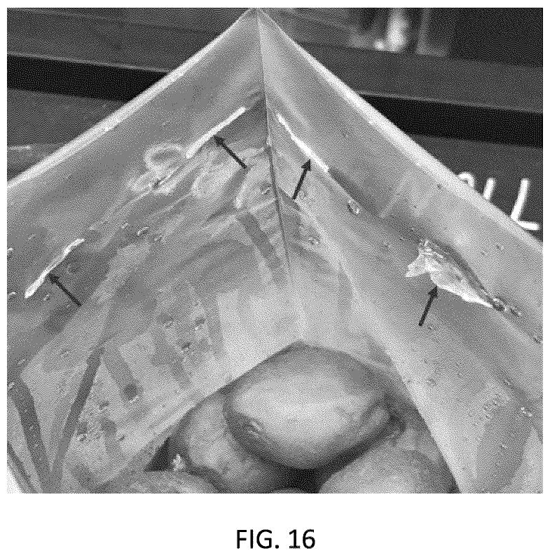

FIG. 16 illustrates results from cooking tests that showed sealing spots on the v-shaped skip seal 112 could result in tearing of the primary bag caused by expansion due to built-up steam pressure.

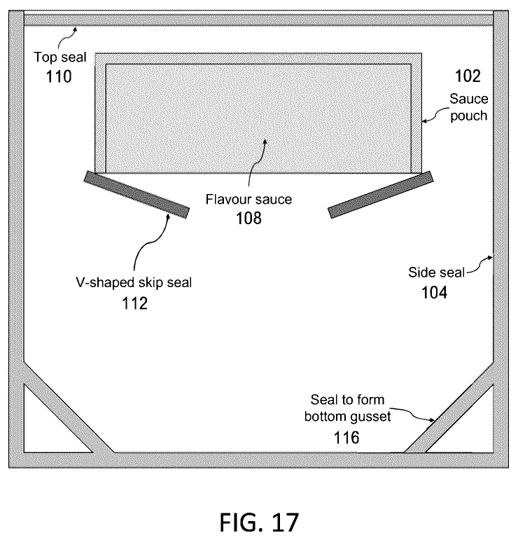

FIG. 17 illustrates that increasing the sealing strength could be achieved by modifying the skip seal design from multiple short sealing spots into two longer sealing lines. The two longer sealing lines are formed using a customized sealing bar fabricated by the primary bag supplier.

The finalized V-shaped skip seal showed promising results to separate sauce pouch from the produce, allow deposit of the flavour sauce, and strengthen the skip seal.

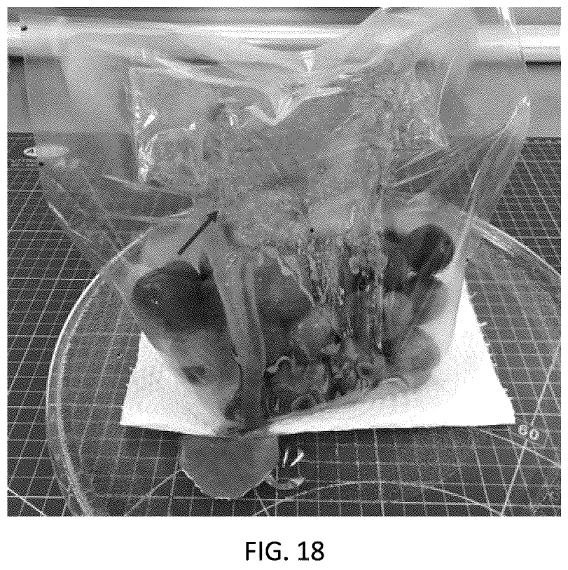

FIG. 18 illustrates results using a stand-up microwavable bag 100a fabricated from a polypropylene/polyester film.

In microwave-cooking, packaging films used to form both primary bags and sauce pouches must resist high temperature and provide substantial sealing strength. For the primary bag, laminated film based on polypropylene and polyester was initially tested. Both polymers are heat-tolerant and have been widely used in microwavable food packaging. However, the flavour sauce can deliver extremely high stress to the V-shaped skip seal when the pouch bursts, leading to film rupture as can be seen in FIG. 18.

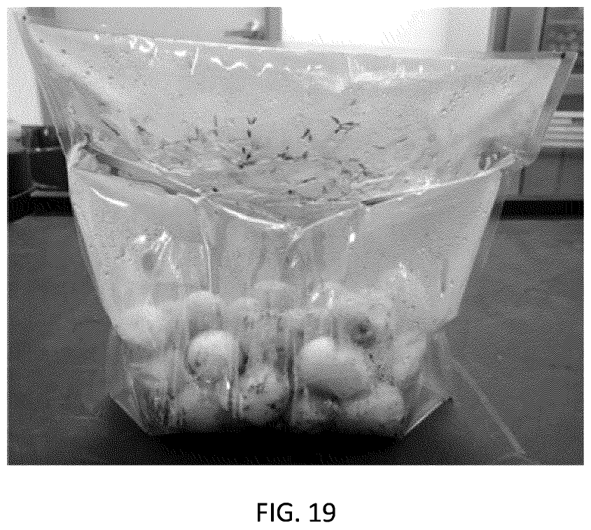

FIG. 19 illustrates results using a stand-up microwavable bag 100a fabricated from a polypropylene/polyamide film.

Based on the results of cooking tests using the polypropylene and polyester film, a different film comprising polypropylene and polyamide was evaluated.

The polypropylene and polyamide film was characterized as high puncture resistant. As can be seen in FIG. 19, this film displayed no rupture when tested in a microwave oven.

Moreover, various packaging materials, such as high-density polyethylene, biaxially oriented polypropylene, and polypropylene laminated with polyester, were trialed to develop the laser-scored sauce pouch.

Testing results showed the entire laser incision burst on the polypropylene/polyester film, but not functioned properly on the rest of testing materials. Therefore, the finalized packaging films were based on polypropylene/polyamide for the primary bag and polypropylene/polyester for the laser scored sauce pouch.

The term “connected”, “attached”, “affixed” or “coupled to” may include both direct coupling (in which two elements that are coupled to each other contact each other) and indirect coupling (in which at least one additional element is located between the two elements).

The foregoing descriptions of specific embodiments of the present disclosure have been presented for purposes of illustration and description. They are not intended to be exhaustive or to limit the disclosure and method of use to the precise forms disclosed. Many modifications and variations are possible in light of the above teaching. The embodiments described were chosen and described in order to best explain the principles of the disclosure and its practical application, and to thereby enable others skilled in the art to best utilize the disclosure and various embodiments with various modifications as are suited to the particular use contemplated. It is understood that various omissions or substitutions of equivalents are contemplated as circumstance may suggest or render expedient, but is intended to cover the application or implementation without departing from the spirit or scope of the claims of the present disclosure.

1. A stand-up bag for microwaving produce, said bag comprising:
opposing parallel walls heat sealed together to form the stand-up bag, having a top, and a base, and forming an inner compartment;
a skip seal formed by heat sealing the opposing parallel walls, dividing the stand-up bag into an upper compartment and a lower compartment;
a breachable sauce pouch contained in the upper compartment;
a series of micro perforations formed in one or more of the opposing parallel walls extending from the inner compartment to an exterior surface; and
a steam valve situated in one of the opposing parallel walls, extending from the inner compartment to an exterior surface.

2. The stand-up bag of claim 1, wherein said base comprises a gusset.

3. The stand-up bag of claim 1, wherein the stand-up bag is fabricated from a film comprising polypropylene and polyamide.

4. The stand-up bag of claim 1, wherein the breachable sauce pouch is fabricated from a film comprising polypropylene and polyester.

5. The stand-up bag of claim 1, wherein the skip seal is in the form of a horizontal dashed seal that extends across the bag, approximately parallel with the top.

6. The stand-up bag of claim 1, wherein the skip seal is in the shape of a chevron extending from opposing edges of the walls down towards a central region of the bag.

7. The stand-up bag of claim 1, wherein the breachable sauce pouch has a breachable section formed by laser scoring.

8. The stand-up bag of claim 7, wherein the laser scoring is in the form of a continuous line, a dotted line or a dashed line.

9. The stand-up bag of claim 7, wherein the laser scoring is between 45 μm-600 μm.

10. The stand-up bag of claim 1, wherein the opposing parallel walls are laser-perforated with micro-holes.

11. The stand-up bag of claim 10, wherein the laser-perforated micro-holes substantially have a 75 μm diameter.
